(19) United States
(12) Patent Application Publication
(10) Pub. No.: US 2023/0014846 A1
(43) Pub. Date: Jan. 19, 2023

(54) Integrity Monitoring System, Method for Operating an Integrity Monitoring System, and Integrity Monitoring Unit

(71) Applicant: Siemens Aktiengesellschaft, Munchen (DE)

(72) Inventors: Rainer Falk, Poing (DE); Christian Peter Feist, München (DE); Steffen Fries, Baldham (DE); Axel Pfau, München (DE); Stefan Pyka, Markt Schwaben (DE); Daniel Schneider, München (DE); Franz Sperl, Oberviechtach (DE)

(73) Assignee: Siemens Aktiengesellschaft, München (DE)

(21) Appl. No.: 17/786,404

(22) PCT Filed: Oct. 22, 2020
(86) PCT No.: PCT/EP2020/079688

§ 371 Date: Jun. 16, 2022

(30) Foreign Application Priority Data
Dec. 17, 2019 (EP) 19216944.9

(51) Int. Cl. G05B 23/02

(52) U.S. Cl. CPC G05B 23/0208; G05B 2223/02

(57) ABSTRACT

Various embodiments of the teachings herein include an integrity monitoring system for runtime integrity monitoring of a control device connected to sensors and/or actuators and comprising an automation device for collecting operating state data of the control device. The system may include an integrity monitoring unit detachably connectable directly to the control device to monitor the integrity status of the control device on the basis of operating state data transferred from the automation device to the integrity monitoring unit.

### CROSS-REFERENCE TO RELATED APPLICATIONS

This application is a U.S. National Stage Application of International Application No. PCT/EP2020/079688 filed Oct. 22, 2020, which designates the United States of America, and claims priority to EP Application No. 19216944.9 filed Dec. 17, 2019, the contents of which are hereby incorporated by reference in their entirety.

### TECHNICAL FIELD

The present disclosure relates generally to the Internet of Things (IoT). Various embodiments of the teachings herein include systems and/or methods for integrity monitoring that may be used in the IoT.

### BACKGROUND

The integrity of automation equipment, in particular control equipment, programmable logic controllers and industrial Internet of Things equipment (IoT equipment) has to be ensured to enable error-free operation. Therefore, it is also necessary to monitor the integrity of such equipment during running operation (“device health check”). At present, attacks on an IT system or an IT-based automation system, i.e. unauthorized access to the detriment of such a system can already be detected by means of suitable devices or software, for example by means of a host-based intrusion detection system (IDS).

For this purpose, it is necessary to install special software for the IDS and to keep it up to date. This is frequently not possible in the case of resource-limited components or components that are critical for operation. It is also frequently not possible to install such software on old equipment (legacy equipment) or equipment that is not connected to the Internet. Licensing regulations, in particular for industrial control systems or plants, can impede the installation of special software.

It is also known to infer the integrity of equipment based on power consumption or electromagnetic radiation (“power fingerprinting”). However, this method has the disadvantage of being very complex since it requires both special hardware and software components and the system has to be trained.

### SUMMARY

The present disclosure describes systems and methods for operating a system that monitors the integrity of automation equipment in running operation and thereby may overcome the aforementioned disadvantages. For example, some embodiments may include an integrity monitoring system (1) for runtime integrity monitoring of at least one control device (2) with the at least one control device (2) connected to sensors and/or actuators and comprising an automation device (15) for collecting operating state data of the control device (2), and an integrity monitoring unit (3) that is detachably connectable directly to the control device (2) in order to monitor the integrity status of the control device (2) on the basis of operating state data transferred from the automation device (15) to the integrity monitoring unit (3).

In some embodiments, there is an interface unit (4) connected to the control device (2) and the integrity monitoring unit (3).

In some embodiments, the interface unit (4) comprises an RS232 interface, a USB interface, an SPI interface, an I2C interface or a backplane bus.

In some embodiments, the integrity monitoring unit (3) is mechanically interlocked with the control device (2).

In some embodiments, the control device (2) is a programmable logic control device, in particular of an industrial plant.

As another example, some embodiments include a method for operating an integrity monitoring system (1) with the following steps: providing the integrity monitoring system (1) with at least one control device (2) connected to sensors and/or actuators and comprising an automation device (15) for collecting operating state data of the control device (2) and with an integrity monitoring unit (3) that is detachably connectable directly to the control device (2) in order to monitor the integrity status of the control device (2) on the basis of operating state data transferred from the automation device (15) to the integrity monitoring unit (3), attaching the integrity monitoring unit (3) to the control device (2) for data transmission, collecting operating state data of the control device (2) in the automation device (15), transmitting the operating state data from the automation device (15) of the control device (2) to the integrity monitoring unit (3), evaluating the operating state data in the integrity monitoring unit (3) in order to check an integrity status of the control device (2), and outputting an integrity status.

In some embodiments, the operating state data is transmitted from the control device (2) to the integrity monitoring unit (3) in a cryptographically protected manner.

In some embodiments, running processes, tasks, memory utilization, processor load, input-output load and/or test values of memory areas, in particular of firmware, RAM and/or a configuration memory are provided as operating state data.

In some embodiments, the integrity monitoring unit (3) is removed while the control device (2) is in running operation, updated and reattached to the control device (2).

In some embodiments, the integrity monitoring unit (3) authenticates itself to the control device (2) and/or the control device (2) authenticates the integrity monitoring unit (3).

In some embodiments, after the evaluation of the operating state data and detection of an integrity violation as the integrity status, a restart, a safe operating mode, an alarm message and/or a log entry takes place.

In some embodiments, the integrity monitoring unit (3) transfers requirements for the type and scope of the operating state data to the control device (2).

In some embodiments, the requirements represent minimum requirements for the operating state data.

In some embodiments, the operating state data comprises payload data (32) and signaling data (33), wherein the payload data (32) is transmitted unidirectionally in a non-interactive manner.

As another example, some embodiments include an integrity monitoring unit (3) for monitoring an integrity status of a control device (2), wherein the integrity monitoring unit (3) is embodied to be detachably connectable to the control device (2).

### BRIEF DESCRIPTION OF THE DRAWINGS

Further features, properties and advantages of various embodiments of the present disclosure emerge from the following description with reference to the accompanying figures. The figures show schematically:

FIG. 1 an integrity monitoring system with an integrity monitoring unit, a control device and a plug-in connection incorporating teachings of the present disclosure;

FIG. 2 an integrity monitoring system with an integrity monitoring unit, a control device and two data connections incorporating teachings of the present disclosure; and

FIG. 3 a flow diagram of a method for monitoring the integrity of a control device incorporating teachings of the present disclosure.

### DETAILED DESCRIPTION

The integrity monitoring systems described herein for runtime integrity monitoring of at least one control device comprise at least one control device. The control device in turn comprises an automation device for collecting operating state data of the control device. The integrity monitoring system further comprises an integrity monitoring unit that is detachably connectable directly to the control device in order to monitor the integrity status of the control device on the basis of operating state data transferred from the automation device to the integrity monitoring unit.

The method described herein for operating an integrity monitoring system comprises several steps. First, the integrity monitoring system is provided. The integrity monitoring system comprises a control device, which in turn comprises an automation device for collecting operating state data of the control device. Furthermore, the integrity monitoring system comprises an integrity monitoring unit that is detachably connectable directly to the control device in order to monitor the integrity status of the control device on the basis of operating state data which is transferred from the automation device to the integrity monitoring unit. The integrity monitoring unit is attached to the control device for data transmission. Operating state data of the control device are collected in the automation device of the control device. The operating state data is transmitted from the automation device to the integrity monitoring unit. In the integrity monitoring unit, the operating state data is evaluated in order to check the integrity status of the control device. The integrity status is then output. The integrity monitoring unit is detachably connectable to at least one of the control devices.

A control device should in particular be understood to be control components, controllers, and control equipment. These can be connected to sensors and/or actuators in order to monitor a technical system and/or to act on the technical system.

Runtime integrity monitoring describes monitoring of integrity while the control device is in running operation.

A control device includes control components, programmable logic controllers and control equipment.

Directly connectable means that the integrity monitoring unit is connected to the control device via a plug-in connection or a cable. In particular, the integrity monitoring unit is not connected to the control device via a network connection.

The integrity monitoring systems and methods described herein can be used to monitor the integrity of a control device in real time, wherein the actual control device can remain unchanged. The integrity monitoring unit is pluggable into the control device. It can be connected to the control device without changing the actual control device. Hence, it is possible to analyze the integrity of a control device during operation without having to intervene directly in the control device. The integrity of the control device is monitored outside the actual control device.

Likewise, it is possible to connect old equipment, equipment with no Internet link or equipment with licensing restrictions to the integrity monitoring unit. The actual equipment does not have to be changed for this purpose. For example, operating state data can be provided via a local equipment interface such as RS232, RS485, JTAG, SPI, I2C, USB or the like. It is also possible to expand the scope of the operating state data provided via a firmware update of old equipment in order to enable more extensive checks.

Furthermore, the operating state data may not be transmitted into a network. It is transferred directly to the integrity monitoring unit. The operating state data may be evaluated directly on the integrity monitoring unit.

In some embodiments, the integrity monitoring system comprises an interface unit connected to the control device and the integrity monitoring unit. In some embodiments, the interface unit comprises an RS232 interface, an RS485 interface, a JTAG interface, a USB interface, an SPI interface, an I2C interface or a backplane bus. A backplane bus which is frequently provided on customary control equipment for linking additional input/output modules is particularly preferable. A hardware interface that is frequently available anyway can also be used for integrity monitoring.

In some embodiments, the integrity monitoring unit is mechanically interlocked with the control device. The interlocking is in particular effected via a one-way locking device, a seal, a rivet bolt, a safety bolt, or a mechanical lock. In some embodiments, this hinders or prevents the unauthorized release or removal of the integrity monitoring unit. In some embodiments, mechanical latching takes place during connection in order to prevent or at least hinder the release of the mechanical connection. In some embodiments, an unlocking device, which can be in particular be actuated by pressing, can be provided on the rear side of the control device or the integrity monitoring system. In some embodiments, the unlocking device is not accessible when the control device is installed with the integrity monitoring unit. This hinders the unauthorized release of the interlocking. Furthermore, it is possible to detect when an integrity monitoring unit has been unlawfully removed, in particular from a broken seal. In some embodiments, the removal of the integrity monitoring unit can also be additionally logged. In this case, the integrity monitoring unit is mechanically connected spatially close to the control device, in particular via a plug-in connection. They are in particular not connected to one another via a network.

In some embodiments, the control device is a programmable logic control device, in particular of an industrial plant or a machine tool. In particular in the industrial field, it is necessary to monitor the integrity of the programmable logic control device during operation, but this is often not desirable within the control device in order to avoid intervention in the actual control device. The detachably connectable integrity monitoring unit also enables continuous monitoring of industrial programmable logic control devices without having to intervene in the actual control device.

In some embodiments, the operating state data is transmitted from the control device to the integrity monitoring unit in a cryptographically protected manner. The safety of the integrity monitoring system may be additionally increased.

In some embodiments, running processes, tasks, memory utilization, processor load, input-output load and/or test values of memory areas, in particular of firmware, RAM and/or a configuration memory are provided as operating state data. Likewise, physical parameters, such as in particular the temperature of the processor, can also be transmitted.

In some embodiments, the integrity monitoring unit is removed, updated and reattached to the control device while the control device is in running operation. Hence, the integrity monitoring unit can advantageously receive updates without the actual control device being changed. This can happen not only during a maintenance window in which the monitored or controlled technical system is not in operative operation, but also during the running operation of the technical system, in particular the industrial plant.

In some embodiments, the integrity monitoring unit authenticates itself to the control device and/or the control device authenticates the integrity monitoring unit. It is advantageously possible for the control device to determine, depending on the authentication certificate used and/or depending on a configuration setup, which operating state data is transmitted. Furthermore, it is possible for the control device only to activate or maintain a regular operating mode for as long as an authenticated permissible integrity monitoring unit is connected.

In some embodiments, the control device identifies and/or authenticates itself to the integrity monitoring unit. Authentication can take place via an authentication certificate and/or an authentication configuration, such as, for example, a symmetric key. The integrity monitoring unit can check whether it is actually connected to the correct control device, in particular to a compatible control device. This can prevent integrity violations being detected incorrectly. In particular, it is possible to check whether the installed firmware version is supported and/or whether the expected project planning data is configured. Runtime integrity monitoring only takes place for a compatible control device.

In some embodiments, after the evaluation of the operating state data and detection of an integrity violation as the integrity status, a restart, a safe operating mode, an alarm message and/or a log entry takes place. A restart in particular takes place after a first detection of an integrity violation and operation in a safe operating mode, an alarm message or a log entry takes place after a continuing integrity violation. In particular, an alarm message can be transmitted to cloud storage.

In some embodiments, the integrity monitoring unit transfers requirements for the type and scope of the operating state data to the control device. No operating state data that cannot be evaluated by the integrity monitoring unit is transferred. In particular, it is also possible to specify minimum requirements for operating state data to be provided. In particular, minimum requirements can establish the type of data and/or a minimum amount of operating data required for the integrity monitoring unit to perform monitoring. In particular, the integrity monitoring unit can also report as a status that it is performing monitoring.

In some embodiments, the operating state data comprises payload data and signaling data, wherein the payload data is transmitted unidirectionally without interaction. This transmission is non-interactive. Here, this means that payload data is only transmitted unidirectionally from the control device into the integrity monitoring unit, whereas it is not possible for payload data to be transmitted from the integrity monitoring unit into the control device. This can in particular be ensured by a hardware-based data diode (one-way gateway), by optical transmission, for example via an optical waveguide or by a dual-port RAM in which one port is a read-only port. Furthermore, this enables the integrity monitoring unit to be developed, tested and updated independently of the critical control functionality.

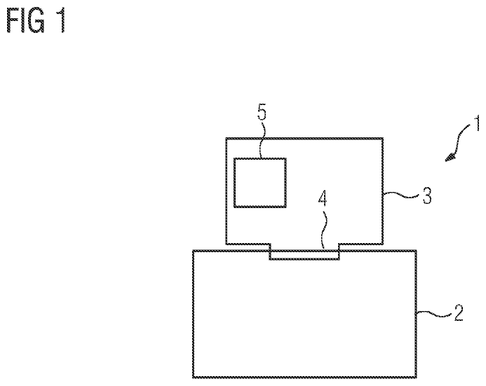

FIG. 1 shows an integrity monitoring system 1 with a control device 2 and an integrity monitoring unit 3. The integrity monitoring unit 3 is detachably connected to the control device 2 by means of a plug-in connection 4. The integrity monitoring unit 3 comprises an output unit 5. The output unit 5 is in particular a light source or a display.

The integrity monitoring unit 3 is a hardware unit that is separate from the control device 2. The integrity of the control device 2 is monitored in the integrity monitoring unit 3 during operation of the control device 2. The integrity monitoring takes place outside the monitored component, i.e. outside the control device 2. Therefore, the integrity monitoring unit 3 can be set up and updated independently of the control device 2. In other words, it is not necessary to modify the monitored component, i.e. the control device 2. This in particular enables runtime monitoring of operationally critical control devices 2.

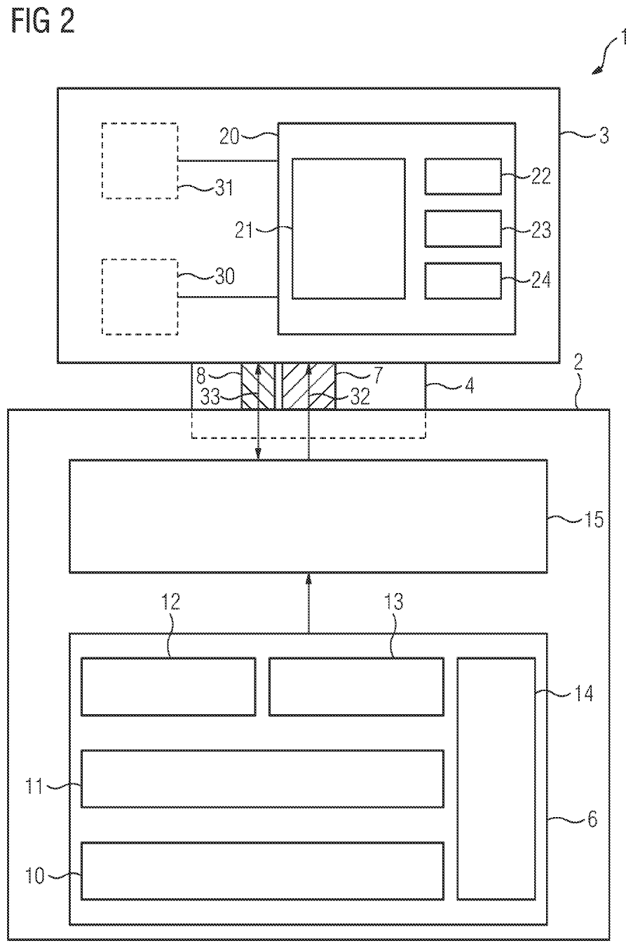

FIG. 2 shows a detailed structure of an integrity monitoring system 1 incorporating teachings of the present disclosure. As already shown in FIG. 1, the integrity monitoring system 1 comprises a control device 2 and an integrity monitoring unit 3. The integrity monitoring unit 3 is in particular in turn linked to the control device 2 via a plug-in connection 4.

The control device 2 comprises a control automation unit 6, which implements the control and monitoring functionality for a technical process. The control automation unit 6 in turn comprises a supervisory unit 13, which implements the actual control functionality according to the project planning data 12 (configuration data), and a self-test unit 14. The self-test unit 14 is, for example, used to detect hardware defects. However, a self-test unit according to the prior art is unable to detect intentional manipulations or an IT attack. The control automation unit 6 furthermore comprises hardware 10, for example a microprocessor, microcontroller, FPGA (field programmable gate array), SoC (system on chip), ASIC (application specific integrated circuit), memory chips (Flash, ROM, EEPROM, RAM) and firmware 11 stored in a memory chip and executed on a microprocessor or microcontroller. Furthermore, project planning data (configuration data) 12 defining the control functionality is stored in the control automation unit 6. The control automation unit 6 passes data for operating the control device 2 to the integrity monitoring data extraction unit 15. In the integrity monitoring data extraction unit 15, operating state data of the control device 2 is read out during operation and, if necessary, made available after preprocessing.

Operating state data can be payload data 32 and signaling data 33. Payload data 32 refers to the data that is essential for operating the control device 2. Signaling data 33 refers to data relating in particular to communication between the control device 2 and the integrity monitoring unit 3. These payload data 32 and signaling data 33 are provided to the integrity monitoring unit 3. In this context, the payload data 32 is preferably transferred unidirectionally to the integrity monitoring unit 3 in a non-interactive manner. Here, non-interactive means that it is not possible to influence the supervisory unit 13, the functionality of the supervisory unit 13, the integrity monitoring data extraction unit 15 or the function thereof via this interface. The signaling data, which in particular specifies the type and scope of the data to be provided from the integrity monitoring unit 3 to the control device 2 or performs authentication processes, is transmitted bidirectionally.

The integrity monitoring unit 3 comprises a runtime monitoring unit 20 with an evaluation unit 21, an updating unit 22, a self-test unit 23 and a compatibility checking unit 24. The runtime monitoring unit 20 is provided with operating state data, in particular reference data 30 and payload data 32. The evaluation unit 21 checks the legitimacy of the received payload data 32 (operating state data of the control device 2) according to the runtime test configuration 31 and the reference data 30.

The updating unit 22 enables the runtime monitoring to be updated. This is possible independently of the updating of the control device 2 and thus can take place independently of operational or regulatory restrictions. This enables a prompt reaction to current attack patterns by importing an updated runtime test configuration 31 and/or reference data 30. The self-test unit 23 of the integrity monitoring unit 3 monitors that the runtime integrity check is actually working properly. This prevents a failure of the runtime integrity check going undetected so that attacks on the control device 2 would go unnoticed.

The compatibility checking unit 24 checks whether the integrity monitoring unit 3 is actually suitable for runtime integrity monitoring of the control device 2. This may prevent an incompatible integrity monitoring unit 3 from being used. This could lead to false alarms and thus jeopardize the reliable operation of the technical system, or it could lead to attacks on the control device 2 not being reliably detected.

The operating state data provided, in particular payload data 32, can be running processes, tasks, memory utilization, processor load, input-output load and/or test values of memory areas, in particular of firmware, RAM and/or a configuration memory. Likewise, physical parameters, such as in particular the temperature of the processor, can also be transmitted.

The signaling data 33 transmitted can in particular be authentication data. In particular, the integrity monitoring unit 3 can authenticate itself to the control device 2.

Depending on the authentication certificates and/or depending on a configuration, the control device 2 can determine which information, in particular which payload data, is issued. Hence, it is possible to prevent operating state data being issued to an unauthorized module.

Furthermore, the signaling data 33 transferred can be information as to which data in the integrity monitoring unit 3 can be evaluated. In particular, minimum requirements for the information to be provided can be specified. In other words, this means the data is established that is required by the integrity monitoring unit 3 in order to be able to perform monitoring and/or to be able to report the status of monitoring that is currently running.

Signaling data 33 can also refer to data that is used for the control device 2 to identify and/or authenticate itself to the integrity monitoring unit 3. In this context, information describing the configuration of the monitored control device 2 can be transmitted from the control device 2 to the integrity monitoring unit 3. This also enables the integrity monitoring unit to check whether it is actually connected to compatible and correct equipment. This can prevent integrity violations being detected incorrectly. In particular, it is also possible to check whether the installed firmware version is supported and/or whether the expected configuration data is configured. Runtime integrity monitoring only takes place for a compatible and correct control device 2.

In the integrity monitoring unit 3, it is also possible to store in the integrity monitoring data extraction unit the reactions triggered in the event of the detection of an integrity violation. In particular, the reaction triggered can be a restart or the activation of an intrinsically safe operating mode or an alarm message, alarm signal or log entry can be generated.

Furthermore, the control device 2 can check whether an integrity monitoring unit 3 is actually present and ready for operation. In one possible embodiment, the control device 2 is only switched to a regular operating mode when the control device 2 is connected to an integrity monitoring unit 3. For this purpose, the control device 2 determines whether an integrity monitoring unit 3 is connected, and, if so, which one. In addition, self-test information and compatibility information can be determined. Depending on the result, the control device 2 activates a regular operating mode or an error operating mode.

Furthermore, it is possible to remove and plug in the integrity monitoring unit during the operation of the control device 2. Hence, the integrity monitoring unit 3 can be replaced while the control device 2 is in running operation. In this context, the control device 2 can document whether and, if so, when, an integrity monitoring unit was plugged in. For this purpose, the control device 2 determines whether an integrity monitoring unit is connected, and, if so, which one, and generates a corresponding log entry.

In this example, the integrity monitoring unit 3 is mechanically interlocked with the control device 2. In this example, mechanical interlocking takes place by means of a seal. However, it is likewise alternatively or additionally conceivable to use a one-way locking device, a rivet bolt or a safety bolt to mechanically interlock the two components to one another. Unauthorized removal of the integrity monitoring unit 3 is hindered or prevented. Furthermore, unauthorized removal of the integrity monitoring unit can be detected on the outside of the control device 2, in particular from a broken seal.

In this example, an integrity monitoring unit 3 monitors one control device 2. However, in some embodiments, it is equally possible for an integrity monitoring unit 3 to monitor a plurality of control devices 2. Hence, the number of integrity monitoring units 3 can be kept low. A larger integrity monitoring unit can in particular also comprise a more powerful safety module. This further increases the safety of the integrity monitoring and also reduces the costs of integrity monitoring during the runtime of the control device 2. Furthermore, it is possible to ensure that a plurality of different control devices 2 are monitored with the same criteria.

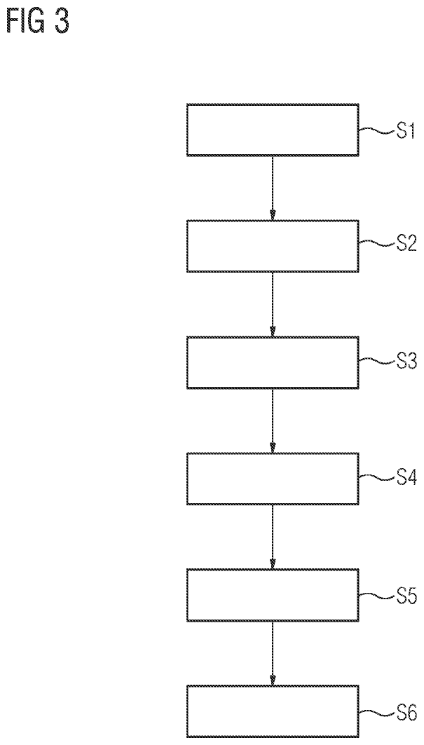

FIG. 3 depicts a flow diagram of an example method incorporating teachings of the present disclosure. First, the integrity monitoring unit is provided in a first step S1. Then, the integrity monitoring unit 3 is attached to the control device 2 in a second step S2. Operating state data of the control device 2 is collected in the automation device 15 in a third step S3. Operating state data is transmitted from the automation device 15 into the integrity monitoring unit 3 in a fourth step S4. The operating state data in the integrity monitoring unit 3 is evaluated in order to check an integrity status of the control device 2 in a fifth step S5. The integrity status is output in a sixth step S6.

Although the teachings herein have been illustrated and described in more detail by exemplary embodiments, the scope of the disclosure is not restricted by the disclosed examples. Other variants can be derived by the person skilled in the art without departing from the scope of protection as defined by the following claims.

### LIST OF REFERENCE SYMBOLS

1 Integrity monitoring system

2 Control device

3 Integrity monitoring unit

4 Plug-in connection

5 Output unit

6 Control automation unit

7 Unidirectional payload data connection

8 Bidirectional signaling data connection

10 Hardware

11 Firmware

12 Project planning data

13 Supervisory unit

14 Self-test unit

15 Integrity monitoring data extraction unit

20 Runtime monitoring unit

21 Evaluation unit

22 Updating unit

23 Self-test unit

24 Compatibility checking unit

30 Reference data

31 Runtime test configuration

32 Payload data

33 Signaling data

S1 Provision of the integrity monitoring unit

S2 Attachment of the integrity monitoring unit to the control device

S3 Collection of operating state data of the control device in the automation device

S4 Transmission of the operating state data from the automation device to the integrity monitoring unit

S5 Evaluation of the operating state data in the integrity monitoring unit in order to check an integrity status of the control device

S6 Output of an integrity status

What is claimed is:

1. An integrity monitoring system for runtime integrity monitoring of
a control device connected to sensors and/or actuators and comprising an automation device for collecting operating state data of the control device, the system comprising:
an integrity monitoring unit detachably connectable directly to the control device to monitor the integrity status of the control device on the basis of operating state data transferred from the automation device to the integrity monitoring unit.

2. An integrity monitoring system according to claim 1, further comprising an interface unit connected to the control device and the integrity monitoring unit.

3. An integrity monitoring system according to claim 2, wherein the interface unit comprises: an RS232 interface, a USB interface, an SPI interface, an I2C interface, or a backplane bus.

4. An integrity monitoring system according to claim 1, wherein the integrity monitoring unit is mechanically interlocked with the control device.

5. An integrity monitoring system according to claim 1, wherein the control device comprises a programmable logic control device.

6. A method for operating an integrity monitoring system, the method comprising:
providing the integrity monitoring system with a control device connected to sensors and/or actuators and comprising an automation device for collecting operating state data of the control device and an integrity monitoring unit detachably connectable directly to the control device to monitor the integrity status of the control device on the basis of operating state data transferred from the automation device to the integrity monitoring unit;
attaching the integrity monitoring unit to the control device for data transmission;
collecting operating state data of the control device in the automation device;
transmitting the operating state data from the automation device of the control device to the integrity monitoring unit;
evaluating the operating state data in the integrity monitoring unit to check an integrity status of the control device; and
transmitting an integrity status.

7. A method according to claim 6, wherein the operating state data is transmitted from the control device to the integrity monitoring unit in a cryptographically protected manner.

8. A method according to claim 6, further comprising providing running processes, tasks, memory utilization, processor load, input-output load and/or test values of memory areas, in particular of firmware, RAM and/or a configuration memory as operating state data.

9. A method according to claim 6, further comprising removing the integrity monitoring unit while the control device is in running operation, updating, and reattaching the integrity monitoring unit to the control device.

10. A method according to claim 6, wherein the integrity monitoring unit authenticates itself to the control device and/or the control device authenticates the integrity monitoring unit.

11. A method according to claim 6, wherein, after the evaluation of the operating state data and detection of an integrity violation as the integrity status, a restart, a safe operating mode, an alarm message and/or a log entry takes place.

12. A method according to claim 6, wherein the integrity monitoring unit transfers requirements for the type and scope of the operating state data to the control device.

13. A method according to claim 12, wherein the requirements represent minimum requirements for the operating state data.

14. A method according to claim 6, wherein the operating state data comprises payload data and signaling data, wherein the payload data is transmitted unidirectionally in a non-interactive manner.

15. (canceled)
